(19) United States
(12) Patent Application Publication
(10) Pub. No.: US 2015/0055874 A1
(43) Pub. Date: Feb. 26, 2015

(54) IMAGE ANALYZING APPARATUS AND METHOD

(71) Applicant: KABUSHIKI KAISHA TOSHIBA, Tokyo (JP)

(72) Inventors: Takuma YAMAMOTO, Kanagawa-ken (JP); Yasunori Taguchi, Kanagawa-ken (JP); Toshimitsu Kaneko, Kanagawa-ken (JP)

(73) Assignee: KABUSHIKI KAISHA TOSHIBA, Tokyo (JP)

(21) Appl. No.: 14/244,012

(22) Filed: Apr. 3, 2014

(30) Foreign Application Priority Data
Aug. 23, 2013 (JP) 2013-173829

(51) Int. Cl. G06T 5/00

(52) U.S. Cl. CPC G06T 5/001
USPC 382/197

(57) ABSTRACT

An image analyzing apparatus includes computer. The computer is programmed to obtain a motion vector from a first image toward a second image and calculate an evaluation value depending on a magnitude of frequency components. The frequency components have a higher frequency than a first frequency determined based on the motion vector. The computer is also programmed to detect a particular area from the first image based on the evaluation value.

### CROSS REFERENCE TO RELATED APPLICATIONS

This application is based upon and claims the benefit of priority from prior Japanese Patent Application No. 2013-173829, filed Aug. 23, 2013, the entire contents of which are incorporated herein by reference.

### FIELD

Embodiments described herein relate generally to an image analyzing apparatus and an image processing method.

### BACKGROUND

Motion blur occurs in a moving image if the moving image was taken while an image sensor or an object was moving. However, a superimposed image or area such as a scrolling ticker or a CG image does not blur even though it moves.

Technology has been proposed to identify an area which moves but does not blur. According to the technology, composite position of the superimposed image has been used. The composite position has been multiplexed to broadcasting signal. However, the area could not be identified without the composition position.

### BRIEF DESCRIPTION OF THE DRAWINGS

FIG. 1 is an exemplary diagram showing a configuration of an image analyzing apparatus according to a first embodiment;

FIG. 2 is another exemplary diagram showing a configuration of an image analyzing apparatus according to the first embodiment;

FIG. 3 is an exemplary view showing an input image to be analyzed;

FIG. 4 is an exemplary view showing an area information;

FIG. 5 is another exemplary view showing an area information;

FIG. 6 is a diagram for explanation of a low-pass filter;

FIG. 7 is an exemplary flow chart showing an operation of the first embodiment;

FIG. 8 is an exemplary diagram showing a configuration of an image analyzing apparatus according to a second embodiment;

FIG. 9 is an exemplary flow chart showing an operation of the second embodiment; and

FIG. 10 is an exemplary view showing a hardware configuration of an analyzing apparatus according to the embodiments.

### DETAILED DESCRIPTION

In general, according to one embodiment, an image analyzing apparatus comprises a computer. The computer is programmed to obtain a motion vector from a first image toward a second image; calculate an evaluation value depending on a magnitude of frequency components, the frequency components having higher frequency than a first frequency determined based on the motion vector; and detect a particular area from the first image based on the evaluation value.

Hereinafter, various embodiments will be described with reference to the accompanying drawing as needed. In the embodiments, like reference numbers denote like elements, and duplicate descriptions are omitted.

### First Embodiment

At first, a brief explanation according to a first embodiment will be provided.

A digital camera for taking a moving image generates an image by opening a shutter for a predetermined time and accumulating light entering on an image sensor. If the image sensor or an object moves, the light which is supposed to be accumulated as one pixel is accumulated as a plurality of pixels. The plurality of pixels exist along the direction of the movement. Therefore, a blurred image is generated. The blur is called motion blur.

However, a superimposed/compounded image or area such as a scrolling ticker and a CG image does not blur even though it moves. Hereinafter, the moving area which is not blurred is called a non-blurred moving area. According to this embodiment, the non-blurred moving area is identified from an input image without using a composite position received from the outside.

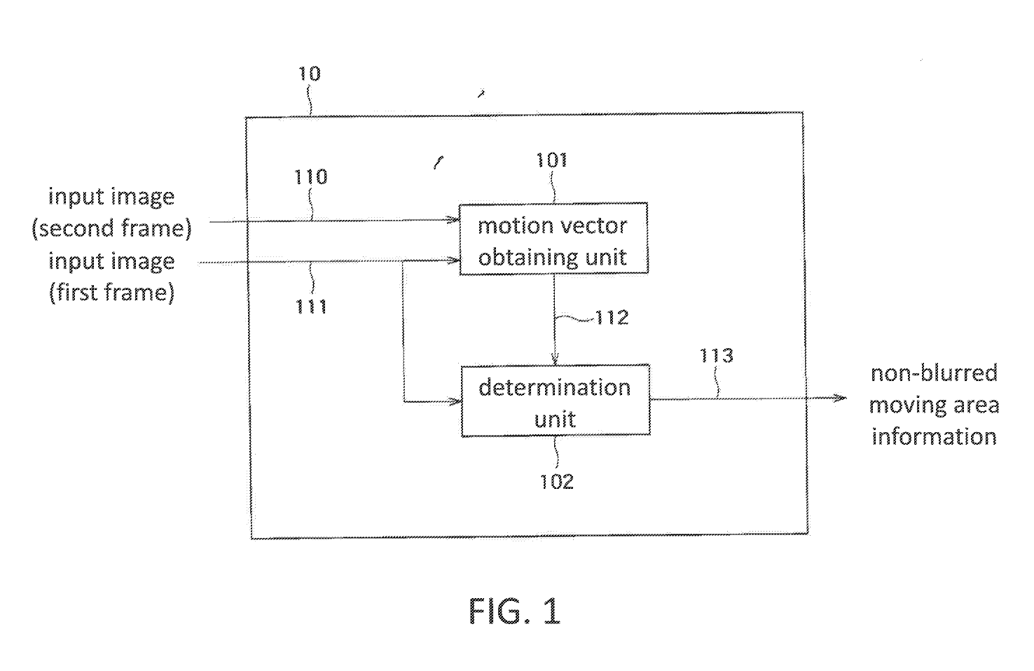

FIG. 1 is an exemplary diagram showing the configuration of an image analyzing apparatus 10 according to a first embodiment. The image analyzing apparatus 10 includes motion vector obtaining unit 101 and a determination unit 102.

The motion vector obtaining unit 101 receives a first frame 111 and a second frame 110 as input images. The first frame 111 and the second frame 110 exist in a moving image and occurs different times. The motion vector obtaining unit 101 obtains a motion vector from the first frame 111 to the second frame 110 for each pixel. A direction for calculating the motion vector is not related to a time direction. The first frame 111 can precede the second frame 110 and the second frame 110 can precede the first frame 111.

The motion vector obtaining unit 101 can use fields instead of frames. For example, a motion vector can be obtained based on two odd-numbered fields, or a motion vector can be obtained based on two even-numbered fields.

A motion vector can be obtained for each line, block or field. In this case, one motion vector is obtained for one line, block or field, and the motion vector is used as motion vectors for all of the pixels included in the line, block or field. A block-matching technique or hierarchical search can be used for determining a motion vector.

If information regarding motion vectors is included in each input frame, motion vectors can be obtained from the information. For example, an input frame encoded by MPEG includes motion vector information which is detected for encoding. In this case, the image analyzing apparatus 10 may not execute motion detection.

The motion vector obtaining unit 101 may obtain a motion vector by executing motion detection, or obtain a motion vector preliminarily stored in storage.

A motion vector 112 obtained by the motion vector obtaining unit 101 and the frame 111 of the input, image are inputted to the determination unit 102. The first frame 111 is analyzed in the determination unit 102. The determination unit 102 calculates an evaluation value for each pixel of the first frame 111. The evaluation value is calculated depending on magnitudes of frequency components which have higher frequencies than a frequency determined based on the magnitude of the motion vector 112. The frequency is determined to be lower as the magnitude of the motion vector 112 becomes larger. For example, the determination unit 102 calculates a higher evaluation value as magnitudes of frequency components which have higher frequencies than a frequency determined based on the magnitude of the motion vector 112 become larger. In this case, the evaluation value is equivalent to reliability. The reliability has a larger value as a possibility for existing pixels in the non-blurred moving area becomes higher. Hereinafter, an explanation in which the evaluation value is equivalent to reliability will be provided.

The determination unit 102 detects a particular area from the first frame 111 based on the reliability. For example, the determination unit 102 determines an area which includes pixels having higher reliability than a threshold as the non-blurred moving area. The determination unit 102 generates area information 113 which expresses the particular area such as the non-blurred moving area. The determination unit 102 outputs the area information 113 to a subsequent part.

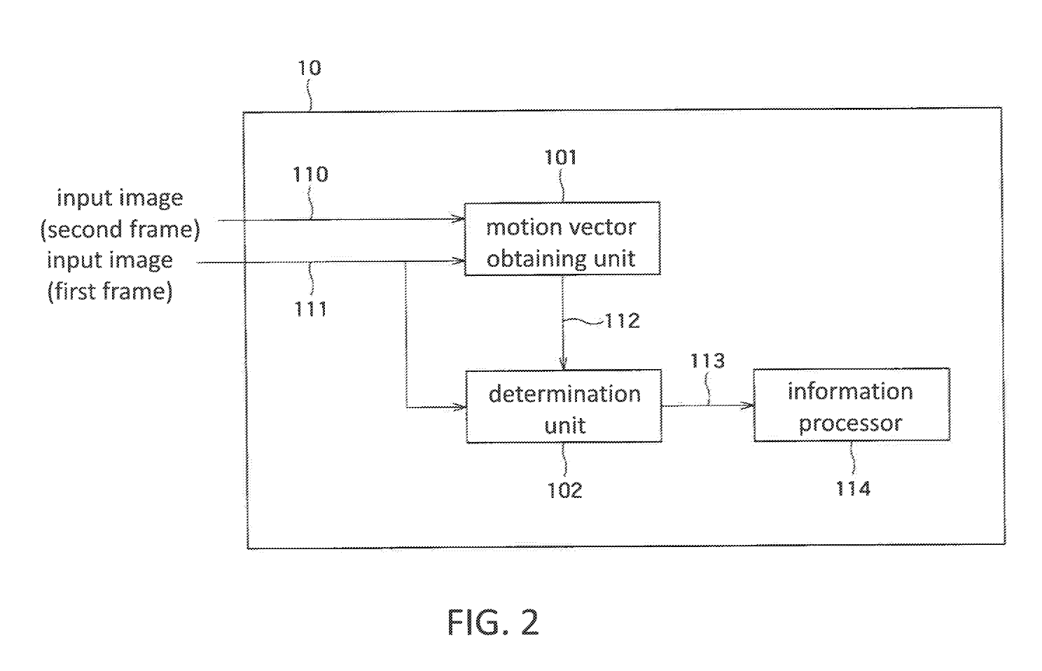

For example, the subsequent part can be an information processor 114 as shown in FIG. 2. The information processor 114 can receive the area information 113 which expresses the non-blurred moving area, and it can detect a scrolling ticker from the non-blurred moving area. Also, the information processor can execute character recognition for the non-blurred moving area, and output a voice reading a text recognized by the character recognition.

The determination unit 102 can detect an area other than the non-blurred moving area as a particular area.

The area information 113 can be binary values which express whether the pixels of the first frame 111 of the input image are included in the non-blurred moving area or not, or the area information 113 can be evaluation values (reliability). Also, the area information 113 can be coordinate values which identify outline of the non-blurred moving area. For example, the outline can be a rectangle.

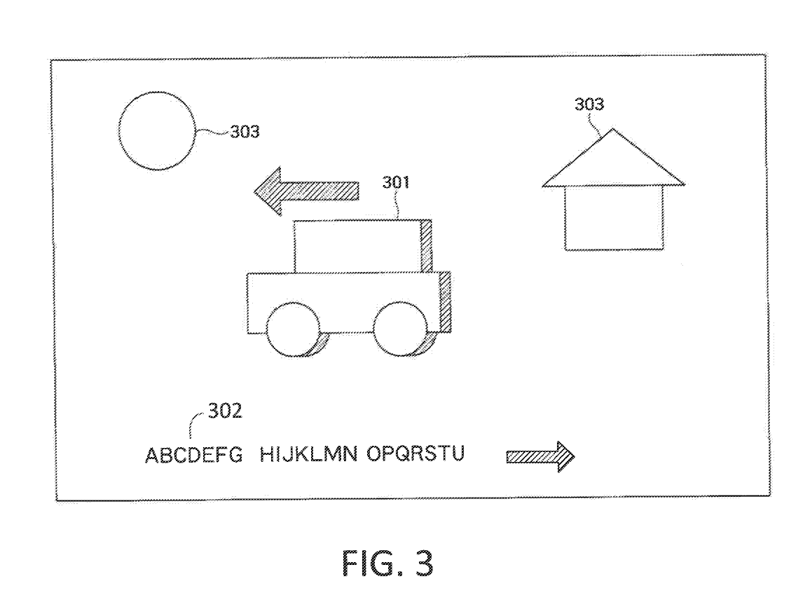

The area information 113 is further explained with reference to FIG. 3. FIG. 3 expresses an example of the first frame 111 of the input image.

A car 301 moving toward the left side, a scrolling ticker 302 moving toward the right side, and two objects 303 without movement are included in the first frame 111. In this case, motion blur occurs on the moving car 301. On the other hand, motion blur does not occur on the scrolling ticker 302, because the scrolling ticker 302 is superimposed on the first, frame 111 after capturing frame images. Also motion blur does not occur on the two objects 303.

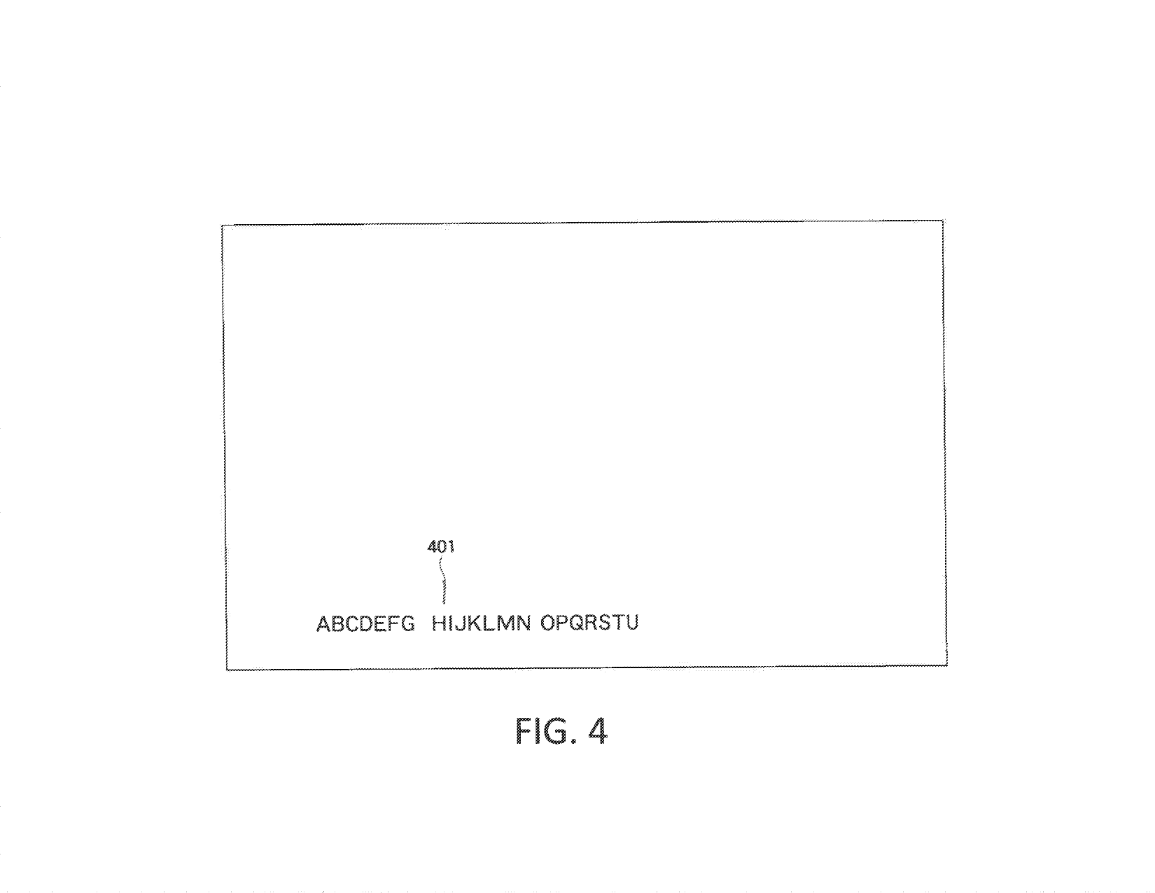

FIG. 4 shows an exemplary view of a non-blurred moving area 401 and another area by two colors. In FIG. 4, a white-colored area indicates an area having reliability lower than a threshold value, and a black-colored area indicates an area having reliability higher than a threshold value. The scrolling ticker moves but does not blur, so the reliability of the scrolling ticker is higher than the threshold value. Therefore an area of the scrolling ticker 302 is detected as a non-blurred moving area. The white-colored area and the black-colored area can be expressed as binary values. For example, values for the white-colored area and the black-colored area can be determined as “0” and “1”, respectively.

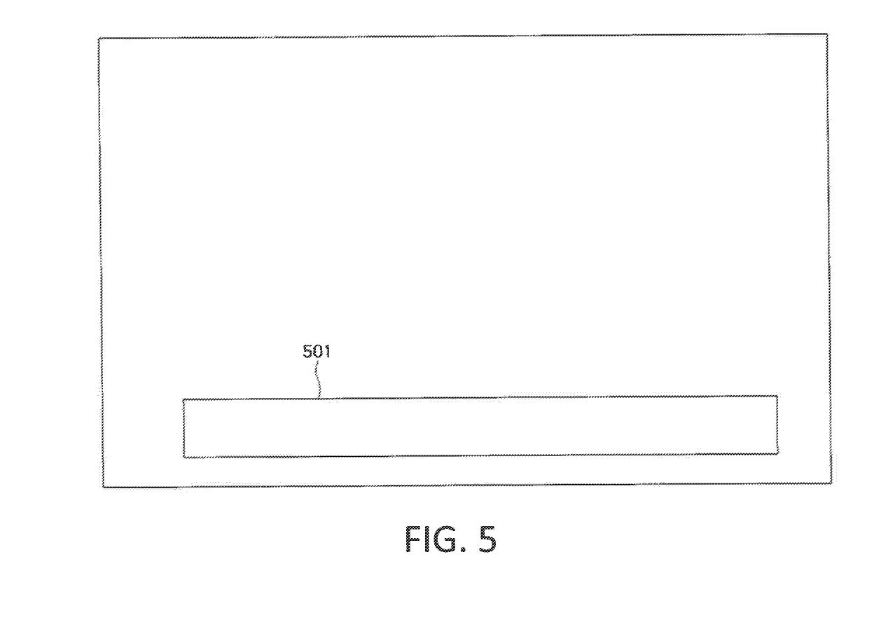

In FIG. 4, the non-blurred moving area is expressed to an accuracy of a pixel. Accordingly, it can be expressed by coordinates of rectangular. For example, as shown in FIG. 5, the determination unit 102 detects a rectangle 501 which includes a scrolling ticker, and a non-blurred moving area can be expressed by the coordinates such as coordinates of four corners of the rectangle 501. Also, a non-blurred moving area can be expressed by a coordinate and a range. For example, the non-blurred moving area can be expressed by a coordinate of an upper left corner, horizontal size and vertical size of the rectangle 501.

Hereinafter, a reliability calculation procedure for a non-blurred moving area will be explained. Although one example of calculating reliability for each pixel of a frame of an input image will be described, the reliability calculation procedure is not limited to the example. Accordingly, the reliability can be calculated for each block of a frame. In this case, the reliability for one pixel of a frame is calculated, and the reliability is applied for the other pixels of the frame.

In an area in which blur occurs, high-frequency components are attenuated. However, in a non-blurred moving area, high-frequency components which are supposed to be attenuated remain. A non-blurred moving area can be considered as an area that includes high-frequency components which are supposed to be attenuated when a blur assumed from a motion vector of the area occurs. Therefore the determination unit 102 calculates a higher reliability as more high-frequency components remain.

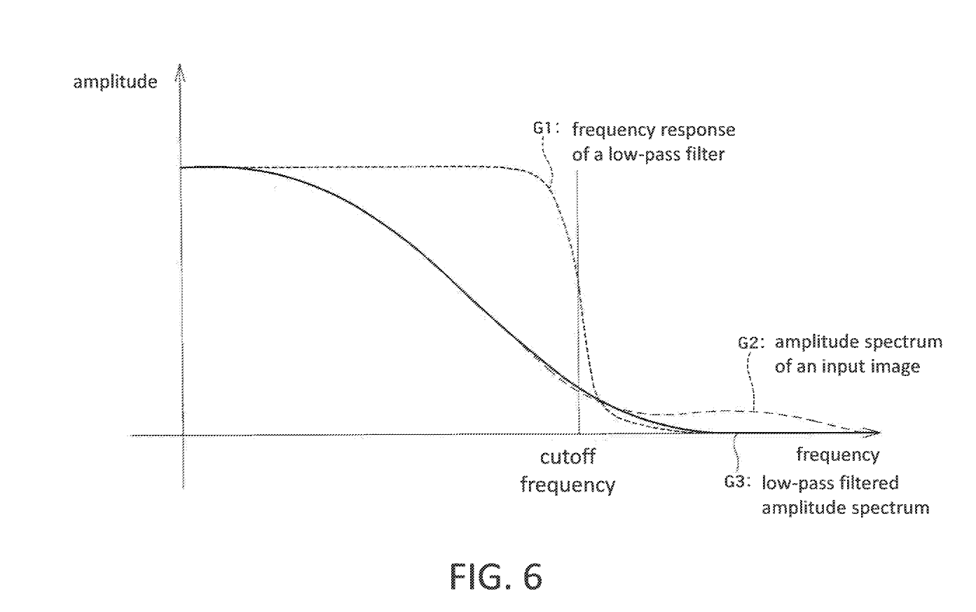

For example, the determination unit 102 can calculate reliability based on a difference between two images. One of the images is obtained by applying a low-pass filter to the first frame 111. A cutoff frequency of the low-pass filter varies in inverse proportion to the magnitude of the motion vector. The other image is the first frame 111. Details are described with reference to FIG. 6.

FIG. 6 is a graph in which the horizontal axis corresponds to frequency, and the vertical axis corresponds to amplitude. G1 shows a frequency response of the low-pass filter. G2 shows an amplitude spectrum of the input image. G3 shows an amplitude spectrum of the input image to which the low-pass filter is applied. If the low-pass filter is applied, the amplitude spectrum is attenuated in a high frequency region in which frequency is higher than a cutoff frequency. More specifically, high frequency components are attenuated by applying the low-pass filter. In the non-blurred moving area, many high frequency components remain. Therefore the area in which high frequency components remain more than a supposed amount can be estimated based on a difference between an image to which the low-pass filter is applied and an image before the low-pass filter is applied. High frequency components are more attenuated as the moving vector becomes larger, so the cutoff frequency of the low-pass filter is set to be lower value as the moving vector becomes larger.

For example, the cutoff frequency can be calculated by equation 1.

$${ω}_{i} = m \frac{1}{\vert \vert u ( i ) \vert \vert} \qquad ( 1 )$$

In equation 1, “i” represents a position vector of a pixel, “u(i)” represents the moving vector on the position i, ωᵢ represents the cutoff frequency on the position i, m represents a parameter set by a designer.

The low-pass filter having cutoff frequency ωᵢ can be calculated by a Fourier series expansion (window function). Specifically, coefficients of the low-pass filter can be calculated by equation 2.

$${h}_{i} ( k ) = \frac{sin ( k {ω}_{i} )}{k π} \qquad ( 2 )$$

In equation 2, hᵢ (k) represents filter coefficients of the low-pass filter. The input image should be multiplied by a window function to suppress Gibbs phenomenon. A Hamming window, Hanning window, Blackman window, or the like can be used as the window function. If the blur occurred on a one-dimensional axis along a direction of movement, a re-blurred image Ir which is obtained by applying the low-pass filter to the input image is calculated by equation 3.

I_{T}(i)=hᵢ [symbol] l(i) (3)

In equation 3, Iᵣ(i) represents pixel value of the position i of first frame 111. The symbol [symbol] represents a convolution integral. The convolution integral performs on a one-dimensional axis along a direction of movement. The reliability, designated p(i) can be calculated by the equation 4.

ρ(i)=|Iᵣ(i)−I(i)| (4)

Although the reliability is determined as an absolute value of a difference of the input image and the low-pass filtered image according to equation 4, it can be determined in other ways. For example the reliability can be determined as a square of that difference.

Although the reliability is calculated by using the low-pass filter, it can instead be calculated by using a high-pass filter.

In the case of using a high-pass filter, the reliability can be determined as a high-pass filtered input image. The cutoff frequency of the high-pass filter is ωᵢ. This means frequency components of the first frame 111 which are lower than the cutoff frequency ωᵢ are attenuated by the high-pass filter. A reliability ρ′ can be calculated by equation 5.

ρ′(i)=hᵢ′ [symbol] I(i) (5)

In equation 5, hᵢ′ represents a filter coefficient of the high-pass filter, which can be calculated by equation 6.

$${h}_{i}^{′ ( k )} = {( - 1 )}^{k} \frac{sin ( k {ω}_{i}^{′} )}{k π} \qquad ( 6 )$$

In equation 6, hᵢ′ (k) represents a k-th (k=0-N) filter coefficient in position i.

ω₁′ is defined by equation 7.

ωᵢ′=1−ωᵢ (7)

The area information 113 can be expressed by binary values by binarizing the reliability with an appropriate threshold. For example, “1” is set for a pixel having greater reliability than the threshold, and “0” is set for a pixel having smaller reliability than the threshold. Then, an area which includes pixels having “1” is determined as area information 113. In the case of detecting other than non-blurred moving area, an area which includes pixels having “0” is determined as area information 113.

The area information 113 can be expressed by coordinate values of a rectangle. In this case, a bounding box of an area which includes pixels having higher reliability than a certain value is calculated, and the coordinate values (for example, coordinate values of four corners) identifying the rectangle are set as the area information 113. The bounding box also can be expressed by one coordinate value (for example, coordinate value of upper left corner) and horizontal and vertical size.

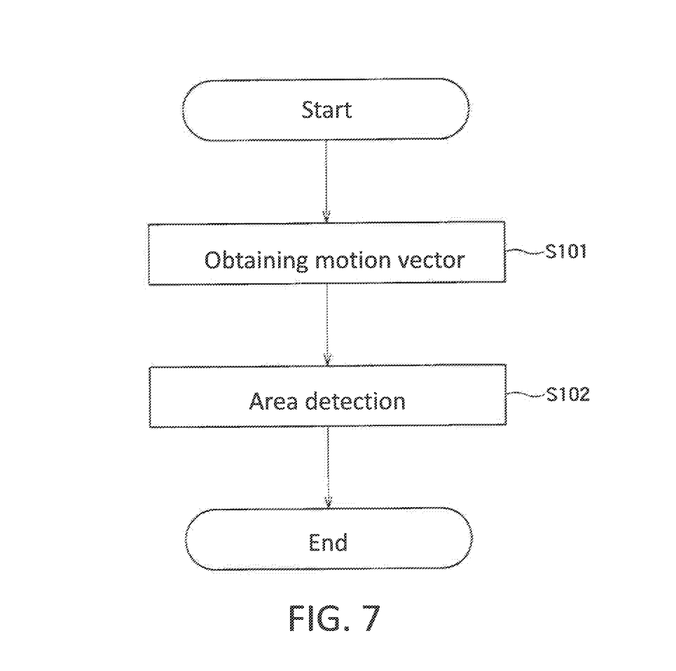

FIG. 7 is a flow chart showing an operation of the image analyzing apparatus 10 according to the first embodiment.

In step S101, the motion vector obtaining unit 101 receives the first frames 111 and the second frame 110 as input images. The frames 111 and 110 exist at different times in the same moving image. The motion vector obtaining unit 101 obtains motion vector 112 toward the second frame 110 for each pixel in the first frame 111. The motion vector can be obtained by motion detection, for example. Motion detection can be executed for each pixel, block, frame, or the like.

In step S102, the determination unit 102 receives the motion vectors 112 detected in the motion vector obtaining unit 101 and the first frame 111 of the input image. Image analysis is executed on the first frame 111. The determination unit 102 creates area information 113 expressing non-blurred moving area. Specifically, reliability (evaluation value) is calculated for each pixel of frame 111. The reliability becomes higher as frequency components higher than a frequency determined based on a magnitude of the motion vector 112 becomes larger. The frequency determined based on the magnitude of the motion vector 112 becomes lower as the magnitude of the motion vector 112 becomes bigger. The determination unit 102 detects an area which includes pixels having higher reliability than a threshold value as a non-blurred moving area. Specific detection methods were previously described. The detection unit 102 generates information representing the non-blurred moving area, and outputs the information.

The image analyzing apparatus according to the first embodiment, detects a non-blurred moving area from input images without using a composite position of a scrolling ticker or a CG image.

### Second Embodiment

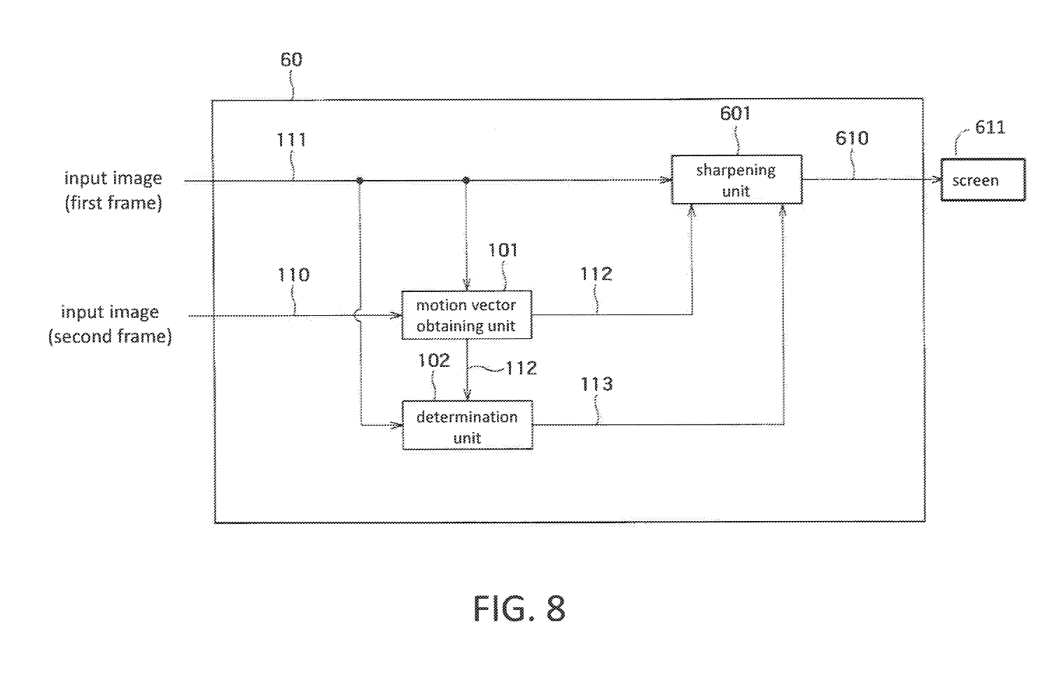

FIG. 8 is an exemplary diagram showing the configuration of an image analyzing apparatus 60 according to a second embodiment. This embodiment differs from the first embodiment in that a sharpening unit 601 is added.

The sharpening unit 601 receives the first frame 111 of the input image, the area information, (non-blurred moving area) 113 obtained by the determination unit 102, and the motion vector 112 output by the motion vector obtaining unit. 101. The sharpening unit 601 generates a sharpened image 610 by carrying out sharpening process for the frame 111, and outputs the sharpened image 610. The image analyzing apparatus 60 can include a screen 611 on which the sharpened image 610 is displayed. The image analyzing apparatus 60 also can send the sharpened image 610 to another device which has a screen.

Hereinafter, the detailed procedure of the sharpening unit 601 is provided.

The sharpening unit 601 carries out sharpening more strongly to an area other than the non-blurred moving area as an absolute value of the motion vector 112 becomes longer. The sharpening unit 601 carries out weak sharpening or does not carry out sharpening of the non-blurred moving area regardless of the absolute value of the motion vector 112. According to this sharpening procedure, greater emphasis on the non-blurred moving area is controlled and high quality images can be obtained.

The sharpening can be implemented by deconvolution which a PSF (Point Spread Function) calculated from an absolute value of the motion vector is used, for example. The PSF operates to apply blur (degradation process). Generally, a blurred image can be generated by convolution of a non-blurred image and the PSF.

Specifically, a sharpened image can be obtained by calculating a variable value x which minimizes the following energy function.

E(x)=∥Kx−b∥²+α∥Rx∥²+β(x−b)^{T}M(x−b) (8)

in which x represents a vector of a sharpened image to be obtained, b represents a vector of the first frame 111 of the input image, R represents a matrix of a Laplacian filter, M represents a matrix in which reliability values are arrayed, α and β represent values which a user determines appropriately, and K represents matrix in which PSF values calculated from the absolute value of the motion vector are arrayed.

The PSF can be expressed by, for example, the following equation based on a Gaussian function,

$${k}_{i} ( t ) = exp ( - \frac{{t}^{2}}{2 \vert \vert u ( i ) {\vert \vert}^{2}} ) \qquad ( 9 )$$

in which kᵢ(t) represents the PSF value in a position vector i upon a parameter t in a motion vector direction. The PSF spreads more widely as the motion vector u(i) becomes longer Although the PSF is expressed based on a Gaussian function in equation 9, the PSF can be expressed based on a rectangular function.

The first term ∥Kx−b∥² of the energy function as indicated in equation 8 functions to cause the image Kx which is blurred from the sharpening image 610 and an input image b (the first frame 111 of the input image) to be closer. The term corresponds to a deconvolution term.

The second term of the energy function is a normalization term which makes it possible to obtain an appropriate solution x even if an inverse matrix of the matrix K does not exist. The second term suppresses the emphasis effect of noise.

The third term of the energy functions to cause the sharpened image and the frame 111 of the input image to be closer in the non-blurred moving area. More specifically, in the non-blurred moving area, sharpening is weakened or sharpening is not carried out.

By minimizing the energy function, the deconvolution based on the absolute value of the motion vector is carried out in an area other than the non-blurred moving area, and the motion blur is eliminated. On the other hand, the deconvolution is restricted in the non-blurred moving area, and an image which is close to the input image can be generated.

The sharpening is not limited to minimizing the energy function as above described. The sharpening can be implemented by a sharpening filter, a shock filter, or the like. By controlling parameters for determining the degree of sharpening of these filters, the sharpening degree can be stronger as the absolute value of the motion vector becomes larger. Also, the sharpening degree can be weak for the non-blurred moving area.

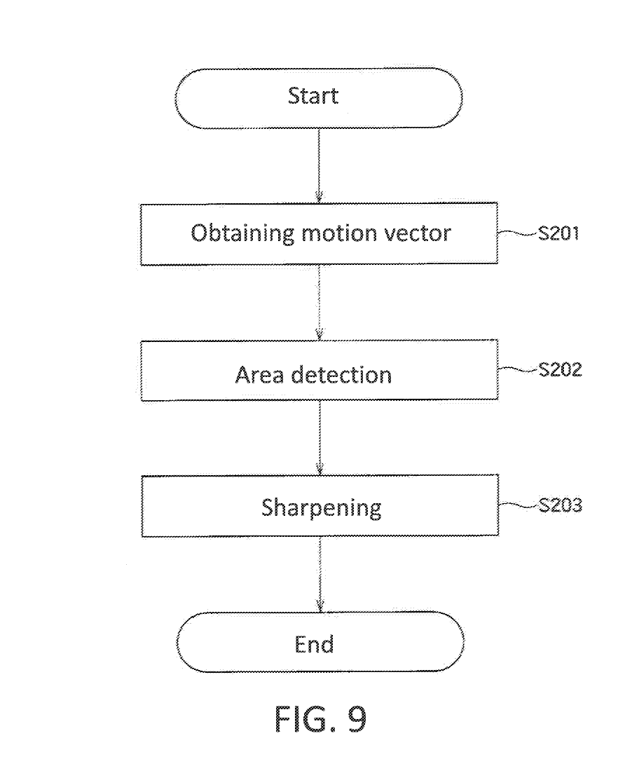

FIG. 9 is an exemplary flow chart showing an operation of the image analyzing apparatus 60 according to the second embodiment.

In step S201, the motion vector obtaining unit 101 receives the first frame 111 and the second 110 as input images. The frames 111 and 110 exist at different times in the same moving image. The motion vector obtaining unit 101 obtains the motion vector 112 toward the second frame 110 for each pixel in the first frame 111.

In step S202, the determination unit 102 receives the motion vectors 112 detected in the motion vector obtaining unit 101 and the first frame 111 of the input image. Image analysis is executed on the first frame 111. The determination unit 102 creates area information 113 representing a non-blurred moving area. The determination unit 102 generates information representing the non-blurred moving area, and outputs the information.

In step S203, the sharpening unit 601 carries out sharpening for the image of the first frame 111. In this case, the sharpening unit 601 carries out weaker sharpening for the non-blurred moving area which is indicated by the area information 113 compared with sharpening for the other area. For example, sharpening is carried out strongly as the absolute value becomes larger in the area other than the non-blurred moving area. On the other hand, in the non-blurred moving area, sharpening is carried out on the image of the first frame 111 so that a pixel value of the frame 111 comes closer to a pixel value of the sharpened image. As a result, in the non-blurred moving area, sharpening is carried out so as to prevent an increase in the difference between these pixel values.

The image analysis apparatus 60 according to the second embodiment carries out sharpening strongly as the absolute value becomes larger in the area other than the non-blurred moving area, and the sharpening is made weak or the sharpening is not carried out in the non-blurred moving area. As a result, the image analysis apparatus 60 can generate a high quality image in which motion blur in the input image is removed and the excessive emphasis in the non-blurred moving area is suppressed.

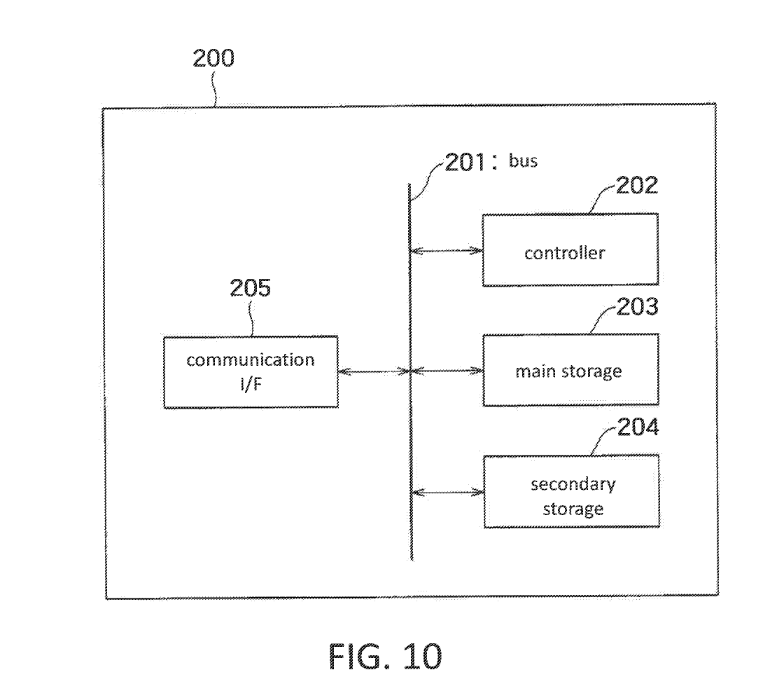

The image analysis apparatus according to either the first or second embodiment can be realized by using a general-purpose computer 200 shown in FIG. 10 as basic hardware. The computer 200 includes a bus 201, and a controller 202, a main storage 203, a secondary storage 204, and a communication I/F 205 are connected to the bus 201. The controller 202 includes a CPU and controls the entire computer. The main storage 203 includes ROM and RAM, and stores data, a program, or the like. The secondary storage 204 includes a HDD or the like and stores data, a program, or the like. The communication I/F 205 controls communication with an external device. The motion vector obtaining unit, the determination unit, and the sharpening unit can be realized by the CPU in the computer. The CPU retrieves a program stored in the main storage or the secondary storage and executes the program. The program can be installed on the computer in advance. Also, the program can be stored in storage media such as a CD-ROM or distributed via a network, and the program can be installed on the computer. The storage storing the input image is realized by the main storage 203, the secondary storage 204, or storage media such as a CD-R, CD-RW, DVD-RAM, and DVD-R.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image analyzing apparatus comprising a computer, the computer programmed to:
obtain a motion vector from a first image toward a second image;
calculate an evaluation value depending on a magnitude of frequency components, the frequency components having higher frequency than a first frequency determined based on the motion vector; and
detect a particular area of the first image based on the evaluation value.

2. The apparatus according to claim 1, wherein the first frequency becomes lower as the motion vector becomes larger in magnitude.

3. The apparatus according to claim 1, wherein the computer is further programmed to obtain a third image by attenuating the frequency components of the first image having higher frequency than the first frequency, and to calculate the evaluation value based on differences between pixel values of the first image and the third image.

4. The apparatus according to claim 3, wherein the attenuating is performed by applying a low-pass filter to the first image, the low-pass filter using the first frequency as a cutoff frequency.

5. The apparatus according to claim 1, wherein the computer is further programmed to obtain a fourth image by attenuating the frequency components of the first image having lower frequency than the first frequency, and to calculate the evaluation value based on the fourth image.

6. The apparatus according to claim 5, wherein the attenuating is performed by applying a high-pass filter to the first image, the high-pass filter using the first frequency as a cutoff frequency.

7. The apparatus according to claim 1, wherein the evaluation value is higher as the frequency components having higher frequency than a first frequency become larger, and the particular area includes one or more pixels having a higher evaluation value than a threshold value.

8. The apparatus according to claim 1, wherein the computer is further programmed to carry out sharpening for the first image, the sharpening for the particular area being weaker than the sharpening for another area of the first image.

9. The apparatus according to claim 8, wherein the sharpening is carried out so as to suppress an increase in a difference between a pixel value of the first image and a pixel value of the sharpened image.

10. The apparatus according to claim 8 further comprising a screen displaying an image obtained by carrying out the sharpening for the first image.

11. An image analyzing method, comprising:
obtaining a motion vector from a first image toward a second image;
calculating an evaluation value based on a difference between the first image and a second image, the second image being obtained by applying a filter to the first image, the filter having a cutoff frequency determined based on the motion vector; and
detecting a particular area of the first image based on the evaluation value.

12. The method according to claim 11, wherein the cutoff frequency becomes lower as the motion vector becomes larger in magnitude.

13. The method according to claim 11, wherein the second image is obtained by attenuating frequency components of the first image having a higher frequency than the cutoff frequency by using the filter.

14. The method according to claim 13, including providing the filter as a low-pass filter.

15. The method according to claim 11, wherein the second image is obtained by attenuating frequency components of the first input image having a lower frequency than the cutoff frequency by using the filter.

16. The method according to claim 15, including providing the filter as the high-pass filter.

17. The method according to claim 11, wherein the evaluation value is higher as the frequency components having higher frequency than the cutoff frequency become larger, and the particular area includes one or more pixels having a higher evaluation value than a threshold value.

18. The method according to claim 11 further comprising carrying out sharpening for the first image, the sharpening for the particular area being weaker than the sharpening for another area of the first image.

19. The method according to claim 18, wherein the sharpening is carried out so as to suppress an increase in a difference between a pixel value of the first image and a pixel value of the sharpened image.

20. The method according to claim 18 further comprising displaying an image obtained by carrying out the sharpening for the first image on a screen.
